(19) United States
(12) Patent Application Publication
(10) Pub. No.: US 2010/0289376 A1
(43) Pub. Date: Nov. 18, 2010

(54) CARBON BRUSH SYSTEM FOR AN ELECTRICAL MACHINE

(76) Inventors: Michael Bayer, Ludwigsburg (DE); Sven Hartmann, Stuttgart (DE)

Correspondence Address: KENYON & KENYON LLP, ONE BROADWAY, NEW YORK, NY, 10004, US

(21) Appl. No.: 12/680,781

(22) PCT Filed: Sep. 22, 2008
(86) PCT No.: PCT/EP2008/062631

§ 371 Date: Jul. 12, 2010

(30) Foreign Application Priority Data
Sep. 30, 2007 (DE) 10 2007 047 760.2

(51) Int. Cl. H01R 39/40

(52) U.S. Cl. 310/242

(57) ABSTRACT

A carbon brush system for an electrical machine, having at least two carbon brushes, which are situated axially adjacent to one another and cooperate with a rotatable countercontact system. The carbon brushes are implemented as directly or indirectly mutually axially supporting carbon brushes.

### FIELD OF THE INVENTION

The present invention relates to a carbon brush system for an electrical machine.

### BACKGROUND INFORMATION

Carbon brush systems for electrical machines are conventional for supplying electrical power to a rotor, for example. For this purpose, they are used for introducing current into countercontact systems, which are implemented, for example, as slip rings or as commutator slip rings. The current is introduced for this purpose via one or more brush pairs into armature windings, in DC motors via a commutator. These brush pairs have brushes for this purpose, which are typically made of a sintered material, which primarily has copper and graphite components. These brushes and the slip rings, in particular the commutator, are subject to wear in operation, which is primarily caused by electroerosive ablation. In particular in commutator systems, a significant electroerosive ablation by sparking is to be observed, which results from the very high current density, which arises in that lamellae of the commutator rotate away under the carbon brushes in operation of the electric motor; as a result, the surface between carbon brushes and countercontact system available for current conduction continually shrinks precisely due to this movement and finally approaches zero, before current is applied to the next lamella. The current density is very high in this case. In order to achieve a longer running time and service life of the electrical machine or its carbon brush system, it is desirable to reduce the current density, in order to decrease the component of the electroerosive wear resulting therefrom. This may reasonably be performed by an extension of the carbon brushes and the slip rings or the commutator in the axial direction, because an extension in the peripheral direction of the slip rings is subject to fundamental limits, in particular in a commutator, in which the lamella width is added as the limiting variable. However, limits are set on such lengthening in the axial direction, because long carbon brushes, which are simultaneously not particularly strong, tend toward instability because of their material structure, are difficult to manufacture, and in particular also the required uniform contact pressure is only to be achieved by special constructions of the carbon brush system, for example, by using leaf-coiled springs; strong sparking occurs in particular in the event of poor contact pressure in the areas of the contact surfaces, which may cause very strong electroerosive ablation and thus significantly reduced service life of the carbon brush. Moreover, the current flow upon the introduction into the carbon brush cross section is concentrated close to the current feed, such as a lead, but in contrast, the edge areas are not optimally reached. Furthermore, conventional commutation systems from other applications may have multiple carbon brushes in the peripheral direction. A multiple carbon brush system for a DC motor is described in Great Britain Patent No. GB 2 244 603 A, the carbon brushes being held connected in parallel via swing arms in a small model construction motor. However, this specific embodiment is not well suited for high-current applications and for oscillation-critical applications. In particular, secure contacting is limited by the design of the swing arms.

### SUMMARY

An object of the present invention is to provide a carbon brush system which avoids the cited disadvantages and may ensure significantly increased expected service life with reliable operation.

For this purpose, an example carbon brush system for an electrical machine is proposed, in particular a commutator system for an electrical machine, having at least two carbon brushes, which are situated axially adjacent to one another and cooperate with a rotatable countercontact system. For this purpose, it is provided that the carbon brushes are implemented as directly or indirectly mutually axially supporting carbon brushes. Therefore, the carbon brushes are implemented in the carbon brush system according to an example embodiment of the present invention in such a way that they either directly or indirectly mutually axially support one another. They are therefore not mounted on separate swing arms, as previously described, which may result in undesired oscillations or vibrations, but rather in such a manner that they are in supporting contact with one another in the axial direction. This contact may be direct, i.e., in such a way that the carbon brushes of the carbon brush system touch one another directly, or indirect, i.e., in such a way that an element which mediates the support is situated between the carbon brushes. This has the advantage in particular that the current flow between the carbon brushes of the carbon brush system may equalize, so that a uniform current density may be achieved in the transmission to the countercontact system.

In a further specific embodiment, it is provided that the carbon brushes are in axial touch contact with one another. The carbon brushes of the carbon brush system touch directly; one side wall of one carbon brush therefore touches another side wall of another, adjacent carbon brush. The equalization of the current flow between the carbon brushes occurs directly between the side walls in this case, so that an equalized current density prevails over all the contact areas on the contact areas to the countercontact system. Simultaneously, the carbon brushes of the carbon brush system mutually support one another in the axial direction, so that significantly better mechanical stability is provided than with carbon brushes situated spaced apart independently of one another. In particular, oscillations, which may be induced in individual carbon brushes and may result in a reduction of the contact pressure and/or the current transmission, are thus reliably avoided.

In another specific embodiment, a wall of a carbon brush socket lies between the carbon brushes. In this specific embodiment, the carbon brushes are mounted, i.e., guided in a housing which at least partially encompasses or envelops them, for example, the wall of the carbon brush socket lying between the carbon brushes to mediate the axial support. Therefore, one carbon brush of the carbon brush system is supported on the wall, the other carbon brush of the carbon brush system being supported on the diametrically opposite side of the wall. In particular if the carbon brush socket is implemented from conductive material, such as metal, particularly good equalization of the current flow between the carbon brushes is also ensured here, in addition, very good and individual radial guiding of the individual carbon brushes of the carbon brush system being possible. Individual wear of the carbon brushes and the accompanying length change may thus be very well taken into consideration.

In a further specific embodiment, the carbon brushes which are in touch contact with one another form a positive connection to one another, in particular a positive connection acting in the peripheral direction. Therefore, the carbon brushes have such a design of the touching side walls that the side walls which are in touch contact implement the positive connection because of this design. For example, it is possible to implement one side wall of one carbon brush as concave, while the other side wall of the other carbon brush, which is in touch contact with the first side wall, is implemented as convexly matching in shape. The side walls of the carbon brushes therefore interlock so that they may not be shifted in relation to one another in the peripheral direction (namely in the rotational direction or opposite to the rotational direction of the electrical machine or the rotor). It is thus ensured that they are always applied to the same segment of the slip rings or the commutator in the axial direction and an offset does not occur in the peripheral direction. The positive connection is simultaneously used as an installation aid.

In a preferred specific embodiment, a separate brush spring is associated with each carbon brush. It is thus ensured that each carbon brush experiences optimum contact pressure in the radial direction acting directly thereon independently of the other carbon brushes. The optimum contacting to the countercontact system is thus ensured for each carbon brush.

In a further specific embodiment, it is provided that the rotatable countercontact system is lamellae of a commutator. As already described, in particular in DC motors using a commutator, the reduction of the current density is particularly desirable. Such a reduction may be achieved very effectively using the proposed system, so that the service life of commutator and carbon brushes may be significantly lengthened.

In a further preferred specific embodiment, each carbon brush has a separate current feed. In this case, the current feeds of the individual carbon brushes of the carbon brush system being electrically connected in parallel, of course, the current introduction into the carbon brushes is optimized with respect to the current flow and the equalization of the current flow within the carbon brushes. A concentration of the current introduction in the carbon brush cross section, as is known from the related art, thus does not occur to a significant extent, but rather, in contrast, is avoided. A very good equalization of the current flow from the current introduction up to the contact surface in the transmission to the countercontact occurs through the embodiment having separate current supplies and direct or indirect mutual axial support, excess current density not occurring at any point of the cross section. The service life of the carbon brushes and the countercontact system, in particular of a commutator, may be significantly increased in this way.

The present invention is described in greater detail below on the basis of exemplary embodiments, without being restricted thereto.

### BRIEF DESCRIPTION OF THE DRAWINGS

FIG. 1 shows a carbon brush system having two carbon brushes situated axially adjacent to one another.

FIG. 2 shows two carbon brushes having a positive connection acting in the peripheral direction.

FIG. 3 shows a carbon brush system having a carbon brush socket which receives the carbon brushes.

### DETAILED DESCRIPTION OF EXAMPLE EMBODIMENTS

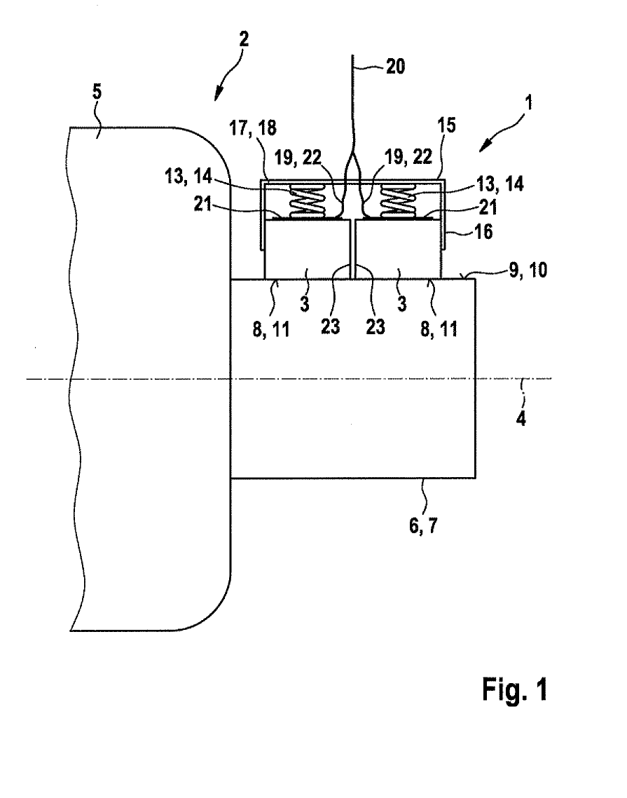

FIG. 1 shows a carbon brush system 1 for an electrical machine 2 (only partially shown). Carbon brush system 1 has two carbon brushes 3, which are situated adjacent to one another in the axial direction, i.e., parallel to a rotational axis 4 of a rotor 5 of electrical machine 2, for example, and cooperate with a rotatable countercontact system 6, for example, of a commutator 7. Contact surfaces 8, which face toward rotatable countercontact system 6 of carbon brushes 3 contact countercontact surfaces 9 of a peripheral surface 10 of rotatable countercontact system 6 for this interaction, so that they rest on one another in a touching position. Contact surfaces 8 are implemented on bottom sides 11 of carbon brushes 3. At least one brush spring 13, such as a spiral compression spring 14, which applies carbon brushes 3 to its top side 12 using a spring force, is provided on top sides 12 of carbon brushes 3 opposite bottom sides 11 of carbon brushes 3 for each carbon brush 3. Brush spring 13 is supported on one side on top side 12 of carbon brushes 3 and on the other side on a carbon brush socket 15, which may be implemented, for example, in the form of an inverted U, in the form of a bow 16, or in another suitable way; it must only be ensured that carbon brush socket 15 suitably guides carbon brushes 3, thus in particular ensures sufficient axial and/or radial guiding of carbon brushes 3. Carbon brush socket 15 is simultaneously used as described for supporting brush springs 13 to apply spring force to top side 12 of carbon brush 3. As a result, contact surface 8 of carbon brush 3 presses against countercontact surface 9 of rotatable countercontact system 6 applying a force. Furthermore, current may be introduced into carbon brushes 3 via carbon brush socket 15, in particular if carbon brush socket 15 is entirely or at least partially made of electrically conductive material 17, such as metal 18. It is preferably provided that each carbon brush 3 has a separate current feed 19, which may each be connected to a current feed cable 20. The current is introduced into carbon brushes 3 in this case on the top side through current feed 19, i.e., on top side 12 of each carbon brush 3. Carbon brushes 3 are electrically connected in parallel in this case; the present carbon brush system 1 shown is therefore monopolar. It is to be repeated for each further required pole of electrical machine 2. Current feed 19 is implemented in this case on the top side, for example, via a lead 22 coupled using a contact plate 21 to carbon brush 3. Due to the current introduction via contact plate 21 on top side 12 of carbon brush 3, the current flow is not concentrated in only a small area already when the current is introduced into carbon brush 3, because lead 22 is connected to carbon brush 3, as is conventional, but rather the lead is connected via the area of contact plate 21. Carbon brushes 3 are situated in the axial direction in such a way that their side walls 23 which are directly diametrically opposite mutually support one another, i.e., diametrically opposing side walls 23 of both carbon brushes 3 touch each other. In this way, the current flow is also distributed uniformly between both carbon brushes 3 via side walls 23, until it reaches contact surfaces 8 on bottom sides 11 of carbon brushes 3 for transmission to rotatable countercontact system 6. A much larger contact surface 8 on carbon brushes 3 and a countercontact surface 9 corresponding thereto on rotatable countercontact system 6 are available for the transmission of the current to rotatable countercontact system 6 in this case, whereby the current density is advantageously decreased upon transmission from contact surfaces 8 to countercontact surfaces 9. The electroerosive wear of both carbon brushes 3 and also rotatable countercontact system 6 may very advantageously be significantly reduced and the service life may be significantly increased in this way.

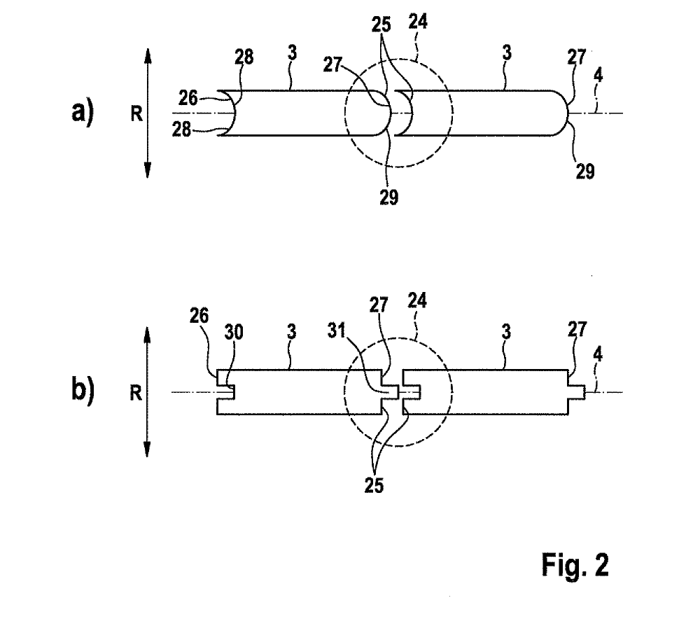

FIG. 2 shows two variants of the geometrical design of carbon brushes 3 in an illustration of carbon brushes 3 in cross section, i.e., in the viewing direction radial to rotational axis 4 of rotatable countercontact system 6 (not shown). Countercontact system 6 (not shown) (compare FIG. 1) rotates about rotational axis 4, whereby forces act on carbon brushes 3 in rotational direction or peripheral direction R (shown as bidirectional), which may result in an offset acting in peripheral direction R, in particular in the form of an offset relative to the radial direction slipping tangentially off of rotatable countercontact system 6 (not shown). Carbon brushes 3 therefore have a geometrical design here such that there is a positive connection 24 between each two adjacent carbon brushes 3 if side walls 25 of carbon brushes 3 support one another axially. Side walls 25 are implemented for this purpose in such a way that one left side wall 26 is implemented as adapted in shape to a right side wall 27 diametrically opposite thereto on the same carbon brush 3. For example, as shown in variant a of FIG. 2, left side wall 26 may be implemented in concave shape 28, while right side wall 27 diametrically opposite thereto is implemented in a convex shape 29 corresponding to concave shape 28. If left side wall 26 of one carbon brush 3 is supported on right side wall 27 of other carbon brush 3, convex shape 29 engages in concave shape 28 in the area of the support, so that positive connection 24 is implemented between carbon brushes 3. This prevents carbon brushes 3 from having an offset relative to one another. A dimensionally stable stabilization of carbon brushes 3, which acts in particular in peripheral direction R, is simultaneously achieved. Left side walls 26 and right side walls 27 may be implemented for this purpose in all geometrical designs which are advisable for a proper positive connection, for example, as shown in variant b of FIG. 2, in the form of a stepped recess 30 in the shape of a groove having a stepped rail 31 corresponding thereto on diametrically opposite side wall 25 of carbon brush 3. Of course, an embodiment (not shown here) via engaging pins and corresponding recesses is also possible, the embodiment as the continuous geometry in the radial direction of carbon brushes 3 having the advantage of taking the wear of carbon brushes 3 into consideration and implementing a reliable positive connection 24 even upon progressing wear of carbon brushes 3.

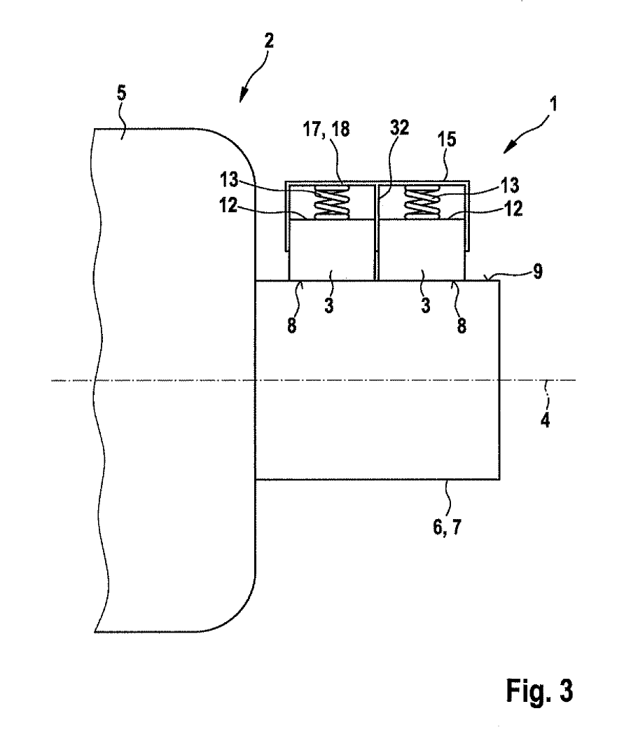

FIG. 3 shows a carbon brush system 1 of an electrical machine 2, in which, as previously described, two carbon brushes 3 cooperate with a rotatable countercontact system 6, such as a commutator 7. Carbon brushes 3 are radially guided in carbon brush socket 15, one brush spring 13 again applying force to each carbon brush 3 between top side 12 of each carbon brush 3 and carbon brush socket 15 for application of force of carbon brushes 3 in the radial direction toward rotational axis 4 of the rotatable countercontact system. In contrast to the exemplary embodiment described in FIG. 1, a wall 32 of carbon brush socket 15, on which both carbon brushes 3 are supported in the axial direction, is situated between carbon brushes 3. Unlike the exemplary embodiment from FIG. 1, in the present case carbon brushes 3 are therefore not supported directly on one another, but rather indirectly via wall 32 of carbon brush socket 15. In addition to the previously described advantages, this specific embodiment offers the advantage that each carbon brush 3 is individually guided in the radial direction, so that varying wear originating from slight material inconsistencies of carbon brushes 3, for example, may be better compensated for via different degrees of change in length of carbon brushes 3 over time. The reduction of the current density in the transmission from contact surfaces 8 to countercontact surfaces 9 occurs independently thereof, as in the exemplary embodiment from FIG. 1. To equalize the current flow between both carbon brushes 3 after current introduction by current feed 19 (not shown here) (compare FIG. 1), wall 32 is preferably made of electrically conductive material 17, in particular metal 18.

1-8. (canceled)

9. A commutator system for an electrical machine, comprising:
at least two carbon brushes which are situated axially adjacent to one another and cooperate with a rotatable countercontact system;
wherein the carbon brushes are mutually axially supporting carbon brushes.

10. The commutator system as recited in claim 9, wherein the carbon brushes are directly mutually axially supporting carbon brushes.

11. The commutator system as recited in claim 9, wherein the carbon brushes are indirectly mutually axially supporting carbon brushes.

12. The commutator system as recited in claim 9, wherein the carbon brushes are in touch contact with one another axially.

13. The commutator system as recited in claim 9, wherein a wall of a carbon brush socket lies between the carbon brushes.

14. The commutator system as recited in claim 12, wherein the carbon brushes which are in touch contact form a positive connection with one another, the positive connection acting in a peripheral direction with one another.

15. The commutator system as recited in claim 9, wherein a separate brush spring is associated with each carbon brush.

16. The commutator system as recited in claim 9, wherein the carbon brushes have a shared carbon brush socket.

17. The commutator system as recited in claim 9, wherein the rotatable countercontact system is lamellae of a commutator.

18. The commutator system as recited in claim 9, wherein each carbon brush has a separate power feed.
